(19) United States
(12) Patent Application Publication
(10) Pub. No.: US 2013/0177691 A1
(43) Pub. Date: Jul. 11, 2013

(54) METHOD FOR PRODUCING ICE CREAM

(71) Applicants: Rudolf Berghoff, Unterschleissheim (DE); Laurentius Rudolf Spindelndreher, Unterschleissheim (DE)

(72) Inventors: Rudolf Berghoff, Unterschleissheim (DE); Laurentius Rudolf Spindelndreher, Unterschleissheim (DE)

(21) Appl. No.: 13/640,072

(22) PCT Filed: Apr. 7, 2011
(86) PCT No.: PCT/EP2011/001739

§ 371 Date: Nov. 26, 2012

(30) Foreign Application Priority Data
Apr. 22, 2010 (DE) 10 2010 017 928.0

(51) Int. Cl. A23G 9/06

(52) U.S. Cl. CPC A23G 9/06
USPC 426/565; 426/524; 426/420

(57) ABSTRACT

A method for producing ice cream includes combining ingredients to form a premix; supplying a cryogenic medium to the premix; and cooling the premix to a temperature below 0° C. During the prefreezing, lump additives which have previously been cooled to a temperature of less than −2° C. are added to the premix.

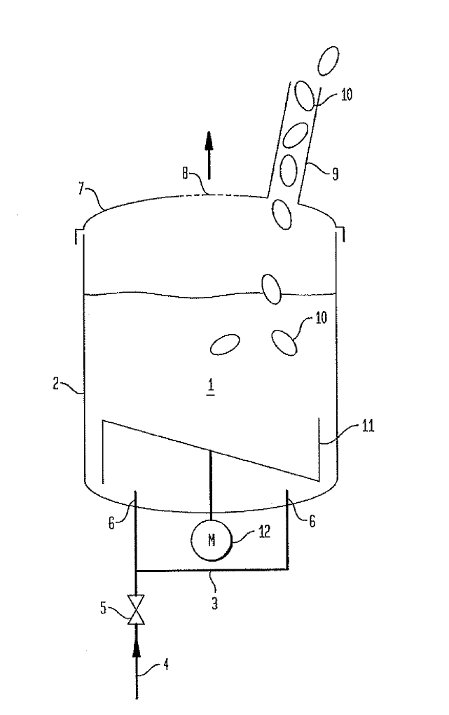

The invention relates to a method for producing ice cream and frozen desserts from ingredients combined in a premix with a cryogenic medium.

Industrial production of ice cream and other frozen desserts is generally performed in several steps. First, some or all of the ingredients are combined in accordance with the desired recipe to form a so-called premix. The premix is then homogenized and pasteurized before being stored temporarily in aging tanks. Next the premix is whipped with air and prefrozen to a soft cream consistency, packaged in the desired portion units and/or drums and finally deep-frozen and hardened in a freezing tunnel.

The whipping and prefreezing of the premix are usually performed in so-called double-jacketed coolers. The premix is introduced into the interior of the cooler and is cooled by a refrigerant flowing in the annular gap of the double jacket. The premix freezes on the inside surface of the cooler and forms a thin layer of ice, which is constantly scraped off by a scraping tool rotating in the interior of the cooler. The water content in the premix is therefore frozen to form small ice crystals, which determine to a significant extent the feel of the ice cream and/or other frozen dessert in one's mouth, the creaminess and the texture of the ice cream.

In this conventional process, it has not previously been possible to add whole fruit, such as berries, large pieces of fruit or fruit particles to the premix, for example. The fruit or pieces of fruit would be damaged by the rotating scraping tool and would be pulverized into fruit puree and/or the pieces would clog the nozzle at the end of the scraping cooler. Introducing frozen fruit pieces into the frozen premix at the end of the scraping cooler also leads to deformation of the fruit pieces and the ice mass. Therefore with the methods known in the past, fruit pieces can only be scattered on the surface of the ice cream and/or frozen dessert after whipping and prefreezing.

DE 10 2006 019 700 A1 describes a method for cryogenic production of ice cream and/or frozen dessert. In this method, the premix is whipped and prefrozen in a mixer to which cryogenic nitrogen is supplied. Liquid nitrogen is sprayed directly into the ice mass and cools it to the extent that it freezes. The nitrogen evaporates in the process and the ice mass is whipped at the same time by the resulting gas bubbles.

Even with this production process, it has so far been impossible to introduce lumpy additives such as pieces of fruit into the ice cream and/or frozen dessert. If the pieces of fruit are added to the premix as additional ingredients, they settle out at the bottom during the prefreezing, regardless of the viscosity of the premix. A uniform distribution of the fruit pieces in the ice mass is completely or mostly impossible.

### OBJECTS AND SUMMARY OF THE INVENTION

The object of the present invention is therefore to provide a method for producing an ice cream and/or frozen dessert which contains additives in large pieces, in particular substances having a sensitive shape, such as pieces of fruit. The piece additives should not be damaged and should be distributed as uniformly as possible in the end product.

This object is achieved by a method for producing ice cream and/or frozen dessert from ingredients, such that the ingredients are combined to form a premix and the premix is prefrozen, so that a cryogenic medium is supplied to the premix in prefreezing and the premix is cooled to a temperature below 0° C. This method is characterized in that additives of large pieces are added to the premix during the prefreezing after having been cooled to a temperature of less than −2° C. before being added to the premix.

The method according to the invention makes it possible to add and incorporate additives in large pieces into ice cream and/or frozen desserts.

Lump additives are understood to refer to non-pasty compositions, solids, particles or lump products. In particular additives which readily lose their shape or are damaged under ambient conditions, i.e., at a temperature of 20° C. and a standard pressure of 1 bar under the influence of external mechanical forces, in particular compressive forces or sharing forces. This refers in particular to additives which would be destroyed mechanically under the conditions prevailing in a scraping cooler for production of ice cream and/or frozen dessert. Lump additives in the sense of this invention include for example fruit, pieces of fruit, nuts or pieces of nuts. All types of additives that would be destroyed by the beater shaft of the scraper cooler, that could damage the scraper cooler or would clog up the nozzle at the end of the scraper cooler can be regarded as lump additives according to the present invention. In the brighter sense this would include not only foodstuffs but also objects such as surprise articles or children's toys which are to be introduced into the ice cream and/or frozen dessert.

The lump additives are preferably more than 5 mm in size, especially between 5 mm and 50 mm, especially preferably between 10 mm and 25 mm. In other words the lump additives have an extent of more than 5 mm, preferably between 5 mm and 50 mm, especially preferably between 10 mm and 25 mm in at least one direction.

The term “ice cream” and/or “frozen dessert” should be understood below to refer to products which are intended for human consumption and are produced from an emulsion of fat and protein with the addition of other ingredients or from a mixture of water, sugar and other ingredients, then treated by freezing and converted to a solid or pasty condition.

Ice cream and frozen desserts are classified in various categories according to the fat content. Depending on the fat content, ice cream may be declared as ice milk (fat content less than 9%), ice cream (fat content more than 10%) or as a gourmet and/or premium variety (fat content 12-13%). The fat may be of animal or vegetable origin. The present invention relates not only to the production of the aforementioned types of ice milk, ice cream and gourmet and/or premium varieties but also to the production of other types of ice desserts such as sorbet, sherbet, frozen yogurt, ice pops and/or pasty compositions in general, which are consumed in the frozen or partially frozen condition.

The invention relates to the industrial production of ice cream and/or frozen desserts as described in the introduction. According to the invention, the ingredients for the frozen dessert are mixed together to form the so-called premix. The premix is optionally homogenized and pasteurized and then prefrozen. For prefreezing, a cryogenic medium is added to the premix, so the premix comes in contact with the cryogenic medium. When the cryogenic medium comes in contact with the premix, the cryogenic medium evaporates or sublimes and withdraws heat from the premix. The resulting gases, which are extremely cold, further cool the premix.

Very high freezing rates and thus greatly shortened freezing times are obtained due to the use of cryogenic media as the refrigerant and due to the direct heat exchange between the premix and the cryogenic medium. In this way, very small micro-ice crystals are formed, so that the mouth feel and creaminess of the ice cream and/or frozen dessert are improved.

The cryogenic medium may be sprayed onto the premix or preferably introduced directly into the premix. The cryogenic medium is advantageously sprayed directly into the premix from underneath or from the side. When the cryogenic medium comes in contact with the premix, the cryogenic medium evaporates or sublimes, resulting in a great deal of turbulence in the premix. An intense heat exchange then takes place. The gaseous cryogenic medium is mixed with the premix and therefore ensures the desired whipping of the premix at the same time.

According to the invention, lump additives are introduced into the premix during this prefreezing. To do so, the additives are cooled to a temperature below −2° C. and are added to the premix in this cooled state. This ensures that the ice mass, which is already partially frozen and/or the partially frozen premix will not be further heated or even thawed due to the additives that have been added. Furthermore, the dimensional stability of the additives is significantly increased by precooling them, so that they are not damaged in the premix. Solid lumps of food items or objects that are to be introduced into the ice cream or frozen dessert according to the invention are precooled before being introduced into the premix in order to prevent heating of the premix.

The liquid, pasty and non-lump additives of the ice cream and/or frozen dessert, such as water, milk, fat or sugar are first processed to form a premix, and then lump additives are added to the premix in the manner according to the invention during prefreezing.

In a preferred embodiment, the lump additives are cooled to a temperature between −2° C. and −7° C. before being added to the premix. This ensures that the additives do not introduce any unwanted heat in to the premix, as described above. Furthermore, the additives must not be too cold because otherwise water could crystallize on the additives and freeze out. The claimed temperature range of −2° C. to −7° C. has proven to be a good compromise on the whole.

The additives should ultimately be distributed in the ice cream as uniformly as possible. It is therefore advantageous to add the lump additives to the premix at a point in time when the viscosity of the premix is so high that the additives neither rise to the top nor settle out in the premix. The additives to be added to the ice cream and/or frozen dessert are preferably introduced into the surface of the premix through chutes or tubes and are uniformly undermixed by means of slow-running mixing tools, which are optionally present in the refrigerated volume.

Depending on which type of additives are to be added to the premix, it is advantageous if the premix has a viscosity between 300 mPa s and 2000 mPa s at the time when the lump additives are added. The premix is first cooled by supplying the cryogenic medium until its viscosity has increased into the aforementioned range. Then the additives are added.

The point in time of adding the lump additives can be determined, for example, by continuous measurement of the viscosity of the premix by means of a viscometer, i.e., a measurement instrument for determining the viscosity of the premix or by measuring the power consumption by the drive motor of the mixing tools. As soon as the viscosity of the premix is high enough, the additives are added.

It is also possible to determine the relationship between the quantity of the premix, the addition of cryogenic medium (quantity, duration, rate) and the viscosity of the premix one time. Then on the basis of these data, the point in time when the viscosity is in the aforementioned range and the additives can be added can be determined for a given quantity of premix to be cooled and for a certain flow rate of cryogenic medium. This point in time can also be determined more specifically as a function of the size, shape and density of the additives.

Gaseous or especially preferably liquid nitrogen is advantageously used as the cryogenic medium. Nitrogen is an inert gas which displaces the oxygen in the container holding the premix. This suppresses oxidative changes in aroma and taste and furthermore, the low-oxygen deep-cold environment has an inhibiting effect on the growth of microorganisms.

It is fundamentally also possible to use carbon dioxide in gaseous, liquid or solid form as the cryogenic medium. However, carbon dioxide can alter the pH of the ice mass, so that gaseous nitrogen or in particular liquid nitrogen is preferred. However, carbon dioxide may also be used in a targeted manner for cooling and foaming to produce a “tingling effect” in the mouth and on the tongue when the ice mass is eaten.

The present invention is suitable in particular for introducing fruit pieces or whole fruits into ice cream. Fruit or fruit pieces added to the premix according to the invention can be found undamaged and uniformly distributed in the ice cream end product. Fruit or fruit pieces such as cherries, strawberries, blackberries or raspberries remain attractive. There is no separation of the fruit from the remaining ice mass.

Besides fruit, other pleasure-enhancing consumable foods such as chocolate, chewing gum, candy and the like may be mixed into the ice. The present invention is also suitable, not least of all for introducing non-food items such as small toys into the ice cream or frozen dessert.

### BRIEF DESCRIPTION OF THE DRAWING

The present invention as well as additional details of the invention are explained in greater detail below on the basis of the exemplary embodiment illustrated in the drawing, in which:

The FIGURE shows a device for implementing the method according to the invention.

### DETAILED DESCRIPTION OF THE INVENTION

The invention relates to a method for producing ice cream. Depending on the ice cream recipe, some or all of the liquid, pasty or non-lump additives are processed to form a premix. Additives that are larger than 10 mm in at least one direction are not added to the premix in this phase. The premix is then homogenized, pasteurized and optionally stored temporarily.

For prefreezing, the premix 1 is placed in a mixer 2, as shown in the FIGURE. The premix 1 is cooled and prefrozen in the mixer 2 by direct heat exchange with a refrigerant. To do so, liquid nitrogen is introduced as a refrigerant into the mixer 2 through a bottom feed system 3. The bottom feed system 3 has a liquid nitrogen inlet 4 with a control valve 5. The liquid nitrogen feed 4 ends in one or more outlets 6 which protrude into the interior of the mixer 2 and a defined quantity of liquid nitrogen can be injected directly into the premix mass 1 through these outlets. The outlets 6 may be arranged in the bottom of the mixer 2 as shown in the FIGURE and/or they may be located in the side walls of the mixer 2 in the area near the bottom. One to ten outlets 6 are preferably provided, especially preferably two to eight outlets 6.

The liquid nitrogen supplied cools the premix 1 so that it is prefrozen. The nitrogen evaporates in this process and the resulting nitrogen gas rises in the premix 1 so that the premix is whipped. The nitrogen gas leaves the mixer 2 through an outlet opening 8 in the cover 7.

Furthermore, a slow-speed stirrer 11, which is driven by a motor 12, is provided in the mixer 2. The stirrer 11 circulates the premix 1 in the mixer 2, thereby ensuring uniform cooling of the premix 1 by the liquid nitrogen supplied.

Finally, the cover 7 has a feed pipe 9 for supplying lump additives 10 to the premix 1.

After filling the mixer 2 with the premix 1, liquid nitrogen is introduced into the premix 1 through the bottom feed system 3. The premix 1 is circulated by means of the stirrer 11 so that the entire premix 1 comes in contact with the nitrogen uniformly and is cooled.

The premix 1 is cooled by the supply of liquid nitrogen to the extent that its temperature is below 0° C. and its viscosity increases to a value between 300 mPa s and 2000 mPa s. Only then are the additives 10 added.

The lump additives 10 are cooled to a temperature between −3° C. and −5° C. before being incorporated into the premix 1. This ensures that the additives 10 will not introduced any unwanted heat into the premix 1 and thaw the premix 1 while on the other hand they will not be too cold, so that water or other ingredients in the premix 1 could crystallize and freeze out.

The precise point in time for adding the additives 10 is determined as a function of the size, shape and density of the additives 10. The additives 10 should not collect at the bottom of the mixer 2 or rise to the top in the premix 1 after being incorporated into the premix 1. Depending on the type of additives 10, this therefore yields an optimal viscosity range for adding the additives 10 to the premix 1.

The viscosity of the premix 1 is determined in the present example by measuring the power consumption of the drive motor 12 of the stirrer 11. The additives 10 are added as soon as the viscosity of the premix 1 is high enough.

A predetermined quantity of lump additives 10, for example, fruit pieces is supplied through the feed tube 9 to the mixer 2. The additives 10 fall onto the premix 1 through the feed tube 9 and are distributed uniformly in the premix 1 by the stirrer 11. Through the supply of additional liquid nitrogen, the premix 1 is prefrozen with the additives 10, which are then uniformly distributed in the mix.

1-9. (canceled)

10. A method for producing ice cream, comprising:
combining ingredients to form a premix;
supplying a cryogenic medium to the premix for prefreezing the premix to a temperature below 0° C.; and
adding lump additives having a temperature of between −2° C. and −7° C. to the premix during the prefreezing.

11. The method of claim 1, further comprising adding the lump additives to the premix when a viscosity of the premix prevents the lump additives from both of rising and settling out of said premix.

12. The method of claim 1, wherein the premix comprises a viscosity between 300 and 2000 mPa s when adding the lump additives.

13. The method of claim 1, wherein the cryogenic medium comprises liquid nitrogen for the prefreezing.

14. The method of claim 1, further comprising adding fruit pieces to the premix.

15. The method of claim 1, further comprising adding food pieces to the premix.

16. The method of claim 1, further comprising adding inedible additives to the premix.

17. The method of claim 1, wherein the lump additives are larger than 5 mm in size.

18. The method of claim 1, wherein the lump additives are between 5 mm and 50 mm in size.
